(19) United States
(12) Patent Application Publication
(10) Pub. No.: US 2026/0002388 A1
(43) Pub. Date: Jan. 1, 2026

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventors: Ömer INAN, Dorsten (DE); Holger SCHIFFER, Meerbusch (DE); Michael SCHOLZ, Essen (DE); Peter SZEGENY, Engelskirchen (DE); Thorsten BENDEL, Oberhausen (DE); Andreas SCHMITZ, Velbert (DE)

(73) Assignee: Kiekert Aktiengesellschaft, Heiligenhaus (DE)

(21) Appl. No.: 18/880,696

(22) PCT Filed: Jun. 2, 2023
(86) PCT No.: PCT/DE2023/100419

§ 371 Date: Jan. 2, 2025

(30) Foreign Application Priority Data
Jul. 11, 2022 (DE) 10 2022 117 241.4

(51) Int. Cl. E05B 77/16; E05B 85/26

(52) U.S. Cl. CPC E05B 77/16; E05B 85/26

(57) ABSTRACT

The invention relates to a method for locking a component that is moveably arranged on a motor vehicle, and a motor vehicle door lock having a motor vehicle lock with a locking mechanism (4) formed by a rotary latch (6) and at least one pawl df), wherein the rotary latch (6) can be engaged in at least one latch position by means of the pawl (15), a reinforcing plate (5), wherein at least the shafts (16, 17) of the rotary latch (6) and at least one pawl (15) can be connected by means of the reinforcing plate (5), a lock holder (2, 18), wherein the rotary latch (6) engages around the lock holder (2, 18) at least in a latch position, and wherein the lock holder (2, 18) can be brought into an engaging position with the reinforcing plate (5).

The invention relates to a motor vehicle lock, in particular a motor vehicle door lock, having a motor vehicle lock with a locking mechanism formed by a rotary latch and at least one pawl, wherein the rotary latch can be latched in at least one latch position by means of the pawl, a lock case for mounting the locking mechanism, wherein the locking mechanism parts are rotatably mounted by means of shafts held in the lock case, a reinforcing plate, wherein at least the shafts of the rotary latch and at least one pawl can be connected by means of the reinforcing plate, and a lock holder, wherein the rotary latch engages around the lock holder at least in one latch position.

A lock for a motor vehicle is used as a locking system where components that are moveably arranged on the motor vehicle, such as doors, flaps or hoods, must be held securely in position during operation of the motor vehicle. The locking systems are of great importance, since the locking systems, as safety-relevant components, must ensure that the components arranged moveably on the motor vehicle are held even in extreme situations. This is easy to understand since, for example, an engine hood that opens unintentionally can put the vehicle driver and/or the occupants in life-threatening situations. On the one hand, the forces acting on the motor vehicle while driving, such as impacts, vibrations or environmental influences, play a role, as do the forces acting on the vehicle in the event of an extreme situation, such as an accident.

In a basic structure of a locking system, a lock holder that can be brought into engagement with the locking system is surrounded by the locking system and the moveable component is secured in its position. For this purpose, a rotary latch preferably engages in the lock holder, wherein in the locked or latched position the rotary latch is held in the latched position by means of a pawl. In the case of side doors in particular, two latch positions in the lock are required. There is a pre-latch position and a main latch position in which the side door is completely closed.

In order to withstand the high holding forces in the event of an accident, but also with regard to the dynamic stresses during operation of the motor vehicle, the locking mechanism formed by a rotary latch and pawl is made of a metal material and mounted on metal shafts, wherein the shafts in turn are held in a metal lock plate of the motor vehicle lock. Such a lock for a motor vehicle is known, for example, from DE 10 2012 214 534 A1. This document discloses a lock case that is in principle made of metal and has a base area with one or more side walls of the lock. One side wall of the lock case always encloses a right angle with the base area. As a rule, there are two side walls that are located opposite one another. The lock case then has a U-shape in a sectional view. If there are no side walls, this is a lock plate that only has one side wall. An entry region in the form of an opening through which the motor vehicle lock can engage with the lock holder is then formed in the side wall and the base plate. When reference is made below to a lock case, this should also include the case of the lock plate.

It is also known from the document that the lock has a reinforcing plate, also made of metal, which is used for the additional rotatable fastening of the rotary latch and/or pawl in order to further stabilize the mounting of the locking mechanism. The rotary latch and the pawl are then usually located between the lock case and the reinforcing plate. The use of the reinforcing plate provides maximum stabilization in the locking mechanism, since the rotary shafts of the locking mechanism parts can be supported on both sides by the lock plate and the reinforcing plate.

Since the components of a lock must be regularly protected from dust and water, a lock in principle comprises a lock housing with a lock cover for covering one or more components of the lock. The lock housing together with the lock cover is usually made of plastics material for reasons of weight and manufacture. The lock housing and the lock cover can be in one piece or in several pieces. Such a cover can also serve to protect against burglary.

The lock holder generally interacts with a locking mechanism of an associated motor vehicle door lock. The lock holder and motor vehicle door lock generally define the motor vehicle door locking means. In conjunction with the locking mechanism in the motor vehicle door lock, the lock holder ensures a secure and reliable closure of the associated motor vehicle door.

For this purpose, the lock holder is usually connected to a motor vehicle body, for example a B or C pillar of the associated motor vehicle body. The motor vehicle door lock, on the other hand, is located in the motor vehicle door to be locked. In principle, this can also be reversed.

Due to the primary closing function of the lock holder in conjunction with the locking mechanism in the motor vehicle door lock, i.e., on the one hand, a particularly safety-relevant component which, on the other hand, is exposed to particular loads in particular in the event of an accident. In fact, the protection of vehicle occupants in the event of a side impact depends substantially on how reliably the lock holder and the locking mechanism interacting therewith are capable of absorbing the forces acting thereon. The primary concern here is that the motor vehicle door remains closed so that safety devices provided in or on the motor vehicle door, such as side airbags, side impact protection, etc., can have the desired effect.

The forces to be absorbed via the interaction between the motor vehicle door lock and the lock holder act directly between the locking mechanism contained in the motor vehicle door lock and the locking pin of the lock holder bracket which engages with the locking mechanism. The locking mechanism is formed by a rotary latch and at least one pawl, wherein after engagement of the rotary latch, during a closing movement of the door element, the pawl engages in the rotary latch in the striker of the lock holder and prevents the door element from opening. The locking mechanism may have a pre-latch and a main latch which can be present in the door lock depending on the door element. Depending on the embodiment of the locking mechanism, the particular latch position, i.e., main latch or pre-latch, can be provided with an opening or closing moment, so that a blocking lever can be used to secure the latch position. In order to be able to absorb the high forces that occur in the event of an accident, the locking mechanism parts are made at least in part from a metal material, mounted in metal shafts and held on a metal lock plate in the vehicle door lock.

In the prior art, various approaches have already been pursued to further develop such lock holders so that they can absorb far more forces than before in the event of a crash, without tearing off or general mechanical damage occurring or being able to occur. In fact, with regard to the lock holder, material deformations and tears are often observed in practice, in particular at the transition from the lock holder bracket to the lock holder plate.

In order to increase the forces which can be absorbed by the lock holder, various approaches have become known. There are various approaches to providing the lock holder or its lock holder bracket with different cross-sectional thicknesses, as described for example in EP 2 031 158 A2, or to specify an elongation of the lock holder by means of an indentation, as disclosed for example in DE 10 2010 021 677 A1. However, this does not adequately reflect the loads which actually occur in practice and the associated cracking behavior of the lock holder in the event of a crash or extreme forces. It has become apparent that the connection between the lock holder bracket and the lock holder plate is particularly important.

DE 10 2014 006 857 A1 discloses a lock holder for a motor vehicle door lock, which lock holder has a lock holder plate and a lock holder bracket attached thereto, wherein the lock holder bracket is designed with a locking pin, a central piece and a connecting pin. To strengthen the connection between the lock holder bracket and the lock holder plate, the publication proposes that the lock holder bracket be positively connected to the lock holder plate via at least one material-thickened region. To ensure a positive connection, the part of the lock holder bracket or the locking pin and/or the connecting pin which protrudes beyond the lock holder plate is compressed. As a result of the compression process, the lock holder plate is also provided with a bulge which ensures that compression caps created on the underside of the lock holder plate as a result of the compression process can abut at a distance from the locking pin on the one hand and the connecting pin on the other hand in relation to the body.

The solutions known from the prior art have generally proven themselves, but are reaching their limits with newer developments in the automotive industry. The use of batteries in hybrid or electric vehicles increases the loads caused in the event of an accident. The batteries present in the motor vehicle increase the total weight of the vehicle many times over, so that the loads on the locking mechanism and the lock holder in the event of an accident are also increased. Consequently, approaches must be found to increase the strength of the lock holder. This is where the invention comes in.

The object of the invention is to provide an improved lock holder for a motor vehicle door lock. In particular, it is an object of the invention to improve the load capacity of the lock holder and to increase the tear resistance of the system consisting of the lock and the lock holder.

According to the invention, the object is achieved by the features of independent claim 1. Advantageous embodiments of the invention are specified in the dependent claims. It should be noted, however, that the embodiments described below are not restrictive; rather, any variation of the features described in the description and the dependent claims is possible.

According to claim 1, the object of the invention is achieved in that a lock holder for a motor vehicle door lock is provided, having a lock holder plate, a lock holder bracket which is secured to the lock holder plate, wherein the lock holder bracket is formed with a locking pin, a central piece and a connecting pin, and wherein the lock holder bracket is formed in at least two parts. The design according to the invention of the lock holder now makes it possible to design the lock holder bracket so that it can be individually adapted to the loads and, in particular, to the extreme loads in the event of an accident. The individual loads in the event of an accident are particularly relevant to safety, as it must be ensured that the doors, flaps or hoods remain closed, in particular in the event of an accident. The side doors are particularly important because the occupants of the motor vehicle must be protected. Now, in combination with the secure locking of the door, the other safety systems such as seat belts and airbags can develop their full effect. The loads during a crash are extremely high and are simulated by tensile tests when designing the lock holder. The lock holder is subjected to a tensile test until it breaks in order to determine whether the defined specifications are met and to identify weak points so that the lock holder can be designed individually. In particular, this is where the invention comes in and shows a way to improve the load capacity of the lock holder.

According to claim 1, the object of the invention is achieved in that a motor vehicle lock, in particular a motor vehicle door lock, is provided, having a motor vehicle lock with a locking mechanism formed by a rotary latch and at least one pawl, wherein the rotary latch can be engaged in at least one latch position by means of the pawl, a reinforcing plate, wherein at least one shaft of the rotary latch and at least one shaft of the pawl can be connected to the reinforcing plate by means of the reinforcing plate, a lock holder, wherein the rotary latch engages around the lock holder at least in a latch position, and wherein the lock holder can be brought into an engaging position with the reinforcing plate. By means of the structure according to the invention, the object of the invention is achieved in terms of device technology and a motor vehicle lock is provided which has an increased load capacity, in particular with regard to tensile strength. The locking system formed by a motor vehicle lock and a lock holder, which additionally interact with one another via the reinforcing plate, can provide a number of advantages in terms of tensile strength. In addition to supporting the shafts of the locking mechanism, which are preferably accommodated in the lock case, the reinforcing plate can also be used to stabilize the locking system in the event of an extreme load. In particular, the interaction of the reinforcing plate and the lock holder can increase the tensile strength of the vehicle lock. The reinforcing plate serves as a means of support in the event of relative movement between the lock holder and the vehicle lock.

If, according to the invention, reference is made to a lock for a motor vehicle, this lock can be used wherever pivotably and/or displaceably mounted components are arranged on the motor vehicle. This means, for example, flaps, hoods, sliding doors, side doors or covers, without restricting the area of use only to these components. Preferably, the arrangement according to the invention of the reinforcing plate is used in side doors for motor vehicle locks.

The locking mechanism has a rotary latch and at least one pawl. However, locking mechanisms are also known which are equipped with two or more pawls or latching or blocking levers. The reinforcing plate preferably engages around at least the rotary latch and the pawl directly in engagement with the rotary latch and connects the shafts of the locking mechanism parts to one another. However, in the case of locking mechanisms with more than one pawl, the reinforcing plate can also engage around and stabilize or secure more than two shafts, namely all components engaged with the locking mechanism and the rotary shafts thereof. It is also known that the reinforcing plate is also used, for example, to support gear wheels arranged in the motor vehicle lock.

As described in the introduction, the lock plate, which can also be designed as a lock case, is made of a metallic material, in particular as a stamped part. Reference is made to a lock plate when the metallic reinforcement in the motor vehicle lock has a planar extension. If the lock plate also has a bent portion which, for example, engages around the entry region of the lock holder, this is referred to as a lock case. The lock case can have one, two or more bent portions and can engage around the lock housing at least in certain regions. In the following, the term “lock plate” is used for all these embodiments. The locking mechanism parts are held in metal shafts on the lock plate, wherein the metal shafts and the reinforcing plate can also be held in a secured position. The locking mechanism parts are thus mounted in the lock case and the reinforcing plate.

As already indicated above, the lock holder according to the invention not only relates to a side door, but can also be used in the region of a hood, tailgate, sliding door, cover, foldable seats, etc., in other words wherever components used on the motor vehicle in a pivoting or sliding manner must be held securely in their position by means of a locking mechanism.

In a further development of the invention, the reinforcing plate can be brought into an engaging position between the rotary latch and a projection and/or a central piece of the lock holder in at least one latch position of the locking mechanism. The locking mechanism can interact with the lock holder in at least one latch position. Depending on the use of the locking system, two latch positions, i.e. a pre-latch and a main latch, may be required. In at least one latch position, preferably the main latch position, the reinforcing plate is moved into an engaging position between the rotary latch and the projection or the central piece of the lock holder. In other words, the reinforcing plate reaches the region of the lock holder in such a manner that the reinforcing plate can interact with the lock holder.

An interaction between the lock holder and the projection, or between the projection and the central piece, or between the central piece alone, makes it possible for the lock holder to come into contact with the lock holder in the event of an extreme situation in which the lock holder moves relative to and out of the lock. The reinforcing plate can then exert an additional stabilizing effect on the lock holder, thus preventing or delaying a tensile strength, i.e. the lock holder being torn out of the engagement region with the rotary latch. This is an advantage, in particular due to the increased and ever-increasing demands on the load capacity of the vehicle lock, and improves the locking system to meet the increased requirements.

Advantageously, the lock holder has a projection that extends at least in certain regions beyond a locking pin. The design of a lock holder bracket with a projection in the direction of a longitudinal axis of the central piece here makes it possible to provide an extended engagement surface between the lock holder bracket and the reinforcing plate. The lock holder preferably consists of a lock holder plate and a lock holder bracket. Depending on the embodiment and requirements of the lock holder, the lock holder bracket can be made of one or more parts. Depending on the requirements and embodiment, the lock holder bracket can also have an angled, S-shaped or rounded shape, at least in the region of a connecting web. The lock holder bracket consisting of connecting web, central web and locking pin can be connected to the lock holder plate in one or more parts, preferably by means of riveting. An alternative embodiment is formed when the lock holder plate and at least the connecting web and the central web are made in one piece, for example from a sheet steel, and the locking pin is connected to the stamped and bent part on both sides by means of rivets. The invention is therefore not limited to the embodiment of the lock holder, but relates to the interaction of the reinforcing plate with the lock holder. If the lock holder has a projection arranged in an extension of the central piece, it is possible to increase the overlap between the lock holder and the reinforcing plate. An increase in the overlap can in turn lead to an increase in the load capacity of the motor vehicle lock.

If a positive overlap can be achieved between the lock holder and the reinforcing plate, in particular in at least one latch position of the locking mechanism, this results in a further embodiment variant of the invention. The reinforcing plate is at least in certain regions in an overlapping position with the lock holder when at least the pre-latch position, but preferably the main latch position of the locking mechanism is assumed. It can be advantageous if, for example, the reinforcing plate extends positively over at least one region of the locking pin and engages positively around the locking pin at least in some regions. The positive engagement can also extend over the central piece of the lock holder on one or both sides. The positive interlocking allows the overlap between the lock holder and reinforcing plate to be maximized.

If the lock holder has a projection, in particular a projection in the direction of a longitudinal extension of a central piece of the lock holder, this results in a preferred embodiment of the lock holder in interaction with the reinforcing plate. The lock holder has a central piece which extends substantially parallel to the lock holder plate. At the same time, the locking mechanism and in particular the rotary latch moves around the locking bolt. According to the invention, there is at least an overlap in certain regions between the reinforcing plate and the lock holder between the central piece and the rotary latch. If the central piece is now extended beyond the locking pin, this results on the one hand in an embodiment of the lock holder that is simple in terms of construction and manufacturing, but conversely also in an opportunity to increase the overlap between the lock holder and the reinforcing plate. Preferably, the projection is extended in the direction of a longitudinal extension of the central piece, so that an overlap results in the direction of the longitudinal extension of the central piece, in particular beyond the connection region between the locking pin and the central piece.

If the lock holder has a projection in a plane of the central piece of the lock holder, wherein the projection extends substantially in a direction transverse to a center axis of the central piece, a further embodiment variant of the invention results. In addition to forming the projection in the direction of the longitudinal extension of the central piece, the projection can also extend in lateral directions but in a plane with the central piece and in a lateral alignment to a central axis of the central piece. Depending on the space requirements or installation space in the motor vehicle, the projection can therefore extend, for example, at right angles starting from the central piece or a central axis of the central piece. The projection can then be arranged, for example, in the region of the locking pin and in a plane parallel to the central piece or the lock holder plate. When the moveable component is closed and at least one latch position is reached, the reinforcing plate then moves behind the projection and thus makes it possible to increase the overlap and increase the load capacity of the motor vehicle lock.

If the projection extends in more than one direction in a plane of the central piece, an advantageous embodiment of the invention can again be achieved. Depending on the requirements for the load capacity of the motor vehicle lock in the interaction between the motor vehicle lock and the lock holder, the projection on the lock holder can extend in several directions starting from a central axis of the central piece. Thus, according to the invention, it is also possible for the central piece to have a circumferential extension or two or more extensions of projections around the locking pin. Depending on the arrangement in the motor vehicle, in particular, for example, on the B or C pillar of the motor vehicle, a suitable form of overlap or extension or projection can also be selected, for example to ensure a continuous external shape of the projection in order to prevent items of clothing, for example, from getting caught or hooked behind when entering the motor vehicle.

In a preferred embodiment, the reinforcing plate can be brought into an engaging position with the lock holder on at least one side. Depending on the embodiment of the locking system and the lock holder, the reinforcing plate can move to the engagement position or engaging position on one side of the lock holder. One-sided here means that the reinforcing plate extends at least on one side of the locking pin in the direction of the central piece, so that the reinforcing plate extends at least on one side, i.e. on one side of the locking pin, seen in the direction of the longitudinal axis of the central piece, towards the lock holder. Of course, it is also conceivable that the lock plate extends circumferentially and on more than one side towards the central piece and around the locking pin. Preferably, the reinforcing plate engages around the locking bolt and extends at least in certain regions along the projection and/or the central piece.

In an advantageous manner, the reinforcing plate is manufactured as a one-piece stamped part from a stamped and bent part. In order to be able to absorb the high forces in the event of an accident, the reinforcing plate is made from a steel sheet. This is also generally common for the reinforcing plates in use.

In procedural terms, the object of the invention is achieved by providing a method for locking a component that is moveably arranged on a motor vehicle, in particular a side door, with a motor vehicle lock according to one of the preceding claims, in which, when the component is closed and at least one latch position of the motor vehicle lock is reached, a reinforcing plate is moved at least in certain regions into an engaging position with a lock holder. According to the method for locking a moveable component on a motor vehicle, an increase in the tensile strength can be provided in order to enable an increased load capacity for the motor vehicle lock in the event of an accident and thus an extreme load on the motor vehicle. The interaction between the lock holder, reinforcing plate and motor vehicle lock offers the possibility of introducing an additional supporting effect into the lock holder, thereby increasing the stability of the lock.

In the following, the invention is explained in more detail with reference to the accompanying drawings on the basis of exemplary embodiments. However, the principle applies that the exemplary embodiments do not limit the invention, but merely reflect advantageous embodiments of the invention. The features depicted can be implemented individually or in combination with further features of the description as well as what is claimed-individually or in combination.

In the figures:

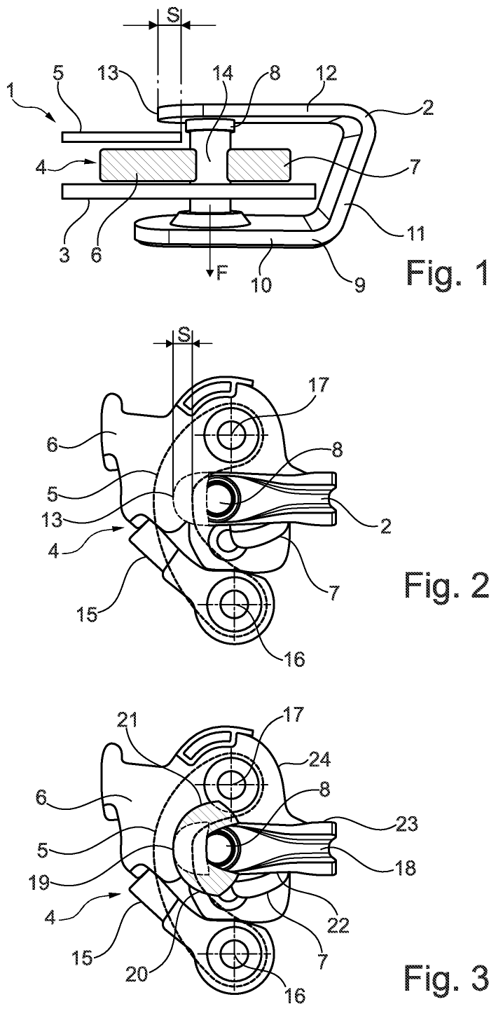

FIG. 1 shows a side view of a motor vehicle lock, with only the components that are essential for explaining the invention being shown; and

FIG. 2 shows a plan view of a motor vehicle locking system according to the invention in a main latch position, and

FIG. 3 shows an alternative embodiment of a projection on the lock holder in interaction with a reinforcing plate.

FIG. 1 shows a basic representation of a motor vehicle door lock 1 in a side view of a lock holder 2, a lock case 3, a locking mechanism 4 and a reinforcing plate 5. FIG. 1 shows the motor vehicle lock 1 in a main latch position of the locking mechanism 4, wherein a rotary latch 6 is shown in engagement with the lock holder 2. A load arm 7 of the rotary latch 6 engages around a locking pin 8 of the lock holder 2. In this exemplary embodiment, the lock holder 2 is formed from a stamped and bent part 9 and a locking pin 8 designed as a pin. Here, the lock holder plate 10, connecting piece 11, central piece 12 and projection 13 are manufactured in one piece from a steel sheet and as a stamped and bent part 9. The locking pin 8 can be connected to the stamped and bent part 9 on both sides, for example by means of riveting.

When the main latch position shown in FIG. 1 is reached, the reinforcing plate 5 reaches an engaging position in which the reinforcing plate slides between the rotary latch 6 and the projection 13. The projection 13 projects beyond the reinforcing plate 5, resulting in an overlap S between the reinforcing plate 5 and the projection 13.

If, in the event of an accident, the lock holder 2 is displaced with an excessive force, the reinforcing plate 5 can support itself against the projection 13. The reinforcing plate therefore reinforces the motor vehicle locking system 1 in the event of extreme loads. In the event of extreme loads, the lock plate 3 or the lock case 3, which is made from a stamped and bent metal part, has a stabilizing effect on the locking mechanism 4 via the metal shafts of the locking mechanism 4, 6. In addition, the reinforcing plate 5 connects at least the rotary shafts of the rotary latch and a pawl, in particular the pre-latching pawl, so that a stabilized motor vehicle lock is provided. This motor vehicle lock, stabilized by the reinforcing plate 5, can now be additionally supported in interaction with the lock holder 2 in such a way that the reinforcing plate rests against the projection 13 of the lock holder 2.

It should be pointed out again that the design of the lock holder 2 is merely shown as an example. The design of the lock holder in the form of a stamped and bent part 9 with a locking pin 8 can also be formed from a different combination. What is essential to the invention here is that a region of the lock holder 2 and in particular the central piece 12 and/or the projection 13 comes into engagement with the reinforcing plate 5 for the locking mechanism 4 in the event of a displacement of the lock holder 2. Likewise, and as shown in the exemplary embodiment, the locking pin 8 can be provided with a plastic coating 14 to minimize noise.

FIG. 2 shows an example of the design of a reinforcing plate 5 and the interaction between the reinforcing plate 5 and the lock holder 2. FIG. 2 shows a plan view of the lock holder 2 and the locking mechanism 4, wherein the main latch position of the locking mechanism 4 is also shown here. The rotary latch 6 engages around the locking bolt 8 with its load arm 7 and is held in the main latch position by a pawl 15.

As can be clearly seen, the reinforcing plate 5 stabilizes the locking mechanism 4, with the pivot axes 16, 17 of the locking mechanism 4 being held by the reinforcing plate. The reinforcing plate 5 is designed such that a projection 13 on the lock holder 2 projects beyond the reinforcing plate 5, so that an overlap S is created between the projection 13 and the reinforcement plate 5. If the lock holder 2 is now displaced relative to the motor vehicle lock, the reinforcing plate 5 comes into engagement with the projection 13 of the lock holder and stabilizes the motor vehicle lock 1. This leads to an increase in strength and a higher load capacity of the motor vehicle door lock. Even if reference is made here to a motor vehicle door lock, the use is not limited thereto, but refers generally to a motor vehicle lock which, in interaction between a locking mechanism 4 and a lock holder 2, holds a component that is moveably arranged on the motor vehicle.

FIG. 3 again shows a plan view of the locking mechanism 4 and a lock holder 18. Identical components are provided with the same reference signs. In this respect, the main latch position of the locking mechanism 4 is again shown, wherein the load arm 7 engages around the locking bolt 8 and is held in the main latch position by the pawl 15. A substantial difference to the aforementioned embodiment is the design of the projection 19, wherein the projection 19 extends at least in certain regions circumferentially around the locking pin 8. In this exemplary embodiment, the projection has two extensions 20, 21, which also extend circumferentially across the reinforcing plate 5. As in the exemplary embodiment according to FIG. 2, in FIG. 3 the projection 19 is arranged in a plane with the central piece 22, so that the projection 19 extends substantially parallel to the reinforcing plate 5, the locking mechanism 4 and the lock case 3 in the motor vehicle lock 1. In the illustrated exemplary embodiment, the projection 19 is designed as a component of the central piece 22 and thus as a component of the central piece, the connecting piece and the lock holder plate 24. Due to the combination and in particular the projection 13, 19 between the reinforcing plate 5 and the overlap S, an additional stabilizing component can be introduced into the motor vehicle lock 1, with alternating stress overall leading to an increased tensile strength.

### LIST OF REFERENCE SIGNS

1 motor vehicle door lock
2, 18 lock holder
3 lock cases
4 locking mechanism
5 reinforcing plate
6 rotary latch
7 load arm
8 locking pin
9 stamped and bent part
10, 24 lock holder plate
11, 23 connecting piece
12, 22 central piece
13, 19 projection
14 plastic sheathing
15 pawl
16, 17 shaft
20, 21 extension
S overlap
F force

1. A motor vehicle door lock comprising:
a locking mechanism including a rotary latch and at least one pawl, wherein the rotary latch is engaged in at least one latch position by the at least one pawl,
a reinforcing plate, wherein at least a shaft of the rotary latch and a shaft of the at least one pawl are connected by the reinforcing plate, and
a lock holder, wherein the rotary latch engages around the lock holder at least in a latch position, and
wherein the lock holder is brought into an engaging position with the reinforcing plate.

2. The motor vehicle door lock according to claim 1, wherein the reinforcing plate, in at least a latch position of the locking mechanism, is brought into an engaging position between the rotary latch and at least one of a projection and/or a central piece of the lock holder.

3. The motor vehicle door lock according to claim 1, further comprising a locking pin, wherein the lock holder includes a projection, and wherein at least a portion of the projection extends beyond the locking pin.

4. The motor vehicle door lock according to claim 1, wherein a positive overlap between the lock holder and the reinforcing plate is achieved in at least a latch position of the locking mechanism.

5. The motor vehicle door lock according to claim 1, wherein the lock holder includes a projection in a direction of a longitudinal extension of a central piece of the lock holder.

6. The motor vehicle door lock according to claim 1, wherein the lock holder includes a projection in a plane of a central piece of the lock holder, wherein the projection extends in a direction transverse to a center axis of the central piece.

7. The motor vehicle door lock according to claim 6, wherein the projection extends in more than one direction in a plane of the central piece.

8. The motor vehicle door lock according to claim 1, wherein the reinforcing plate, at least on one side, is brought into an engaging position with the lock holder.

9. The motor vehicle lock according to claim 1, wherein the reinforcing plate is a one-piece metallic stamped and bent part.

10. A method for locking a moveable component attached to a motor vehicle with a motor vehicle lock according to claim 1, the method comprising the steps of:
when the moveable component is closed and at least one latch position of the motor vehicle lock is reached, moving the reinforcing plate at least in certain regions into the engaging position with a lock holder.

11. The motor vehicle door lock according to claim 1, wherein the lock holder includes a lock holder plate.

12. The motor vehicle door lock according to claim 1, wherein the lock holder includes a lock holder bracket.

13. The motor vehicle door lock according to claim 12, further comprising a connecting web, wherein the lock holder bracket is at least one of angled, S-shaped, and round-shaped in the region of the connecting web.

14. The motor vehicle door lock according to claim 1, further comprising a locking pin, wherein the reinforcing plate engages positively around at least a portion of the locking pin.
